(19) United States
(12) Patent Application Publication
(10) Pub. No.: US 2022/0364511 A1
(43) Pub. Date: Nov. 17, 2022

(54) INTEGRAL FUEL-NOZZLE AND MIXER WITH ANGLED JET-IN-CROSSFLOW FUEL INJECTION

(71) Applicant: General Electric Company, Schenectady, NY (US)

(72) Inventors: Neeraj Mishra, Bengaluru (IN); Jayanth Sekar, Bengaluru (IN)

(21) Appl. No.: 17/317,102

(22) Filed: May 11, 2021

(51) Int. Cl. F02C 7/22

(52) U.S. Cl. CPC F02C 7/22; F05D 2220/32; F05D 2240/35

(57) ABSTRACT

A fuel system for a turbine engine. The fuel system includes a fuel/air mixer configured to mix air with fuel in a controlled fuel/air ratio, the fuel/air mixer having a body defining a chamber. The fuel system also includes a fuel nozzle in fluid communication with the fuel/air mixer. The fuel nozzle is configured to inject fuel into the chamber of the fuel/air mixer. The fuel nozzle is located forwardly relative to the body of the fuel/air mixer so that a jet-in-crossflow of the fuel is angled relative to a foot of the body of the fuel/air mixer.

### TECHNICAL FIELD

The present disclosure relates generally to combustors in turbine engines and in particular to a fuel nozzle and mixer in combustors of turbine engines.

### BACKGROUND

A gas turbine engine generally includes a core, and the core of the gas turbine engine generally includes, in serial flow order, a compressor section, a combustion section, a turbine section, and an exhaust section. A flow of compressed air is provided from the compressor section to the combustion section, wherein the compressed air is mixed with fuel and ignited to generate combustion gases. The combustion gases flow through the turbine section, driving the core.

An igniter is provided within the combustion section or combustor, attached to a casing within the combustion section and extending to or through, e.g., a combustion liner at least partially defining a combustion chamber. Certain gas turbine engines utilize nontraditional high temperature materials, such as ceramic matrix composite (CMC) materials for the combustion liner. Such CMC materials may generally be better capable of withstanding the extreme temperatures within the combustion chamber. The igniter may be movably attached to the combustion liner using a mounting assembly. The mounting assembly may allow for movement of the igniter relative to the combustion liner.

A fuel-nozzle is used to input (spray) the fuel in the combustor of the engine and mixed with air in a determined ratio to form a fuel-air mixture that is ignited by the igniter. Compactness of the fuel-nozzle and the mixer, lower pump pressures, auto-ignition margin while meeting emissions, and weight/cost are key challenges for application of combustor technology (e.g., Twin Annular Premixed Swirl or TAPS) to engines.

### BRIEF SUMMARY

An aspect of the present disclosure is to provide a fuel system for a turbine engine. The fuel system includes a fuel/air mixer configured to mix air with fuel in a controlled fuel/air ratio, the fuel/air mixer having a body defining a chamber; and a fuel nozzle in fluid communication with the fuel/air mixer, the fuel nozzle being configured to inject fuel into the chamber of the fuel/air mixer. The fuel nozzle is located forwardly relative to the body of the fuel/air mixer so that a jet-in-crossflow of the fuel is angled relative to a foot of the body of the fuel/air mixer.

Another aspect of the present disclosure is to provide a turbine engine. The turbine engine includes: (A) a compressor section configured to generate compressed air; (B) a turbine section located downstream of the compressor section; (C) a combustion section disposed between the compressor section and the turbine section; and (D) a fuel system in fluid communication with the combustion section. The fuel system is configured to provide a fuel/air mixture to the combustion section. The fuel system includes: (a) a fuel/air mixer configured to mix air with fuel in a controlled fuel/air ratio, the fuel/air mixer having a body defining a chamber; and (b) a fuel nozzle in fluid communication with the fuel/air mixer, the fuel nozzle being configured to inject fuel into the chamber of the fuel/air mixer. The fuel nozzle is located forwardly relative the body of the fuel/air mixer so that a jet-in-crossflow of the fuel is angled relative to a foot of the body of the fuel/air mixer.

Additional features, advantages, and embodiments of the present disclosure are set forth or apparent from consideration of the following detailed description, drawings, and claims. Moreover, it is to be understood that both the foregoing summary of the present disclosure and the following detailed description are exemplary and intended to provide further explanation without limiting the scope of the disclosure as claimed.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional view of a turbine engine, according to an embodiment of the present disclosure.

FIG. 2 is a schematic, cross-sectional view of the combustion section of the gas turbine engine of FIG. 1, according to an embodiment of the present disclosure.

FIG. 3 is a perspective view of a fuel system 300, according to an embodiment of the present disclosure.

FIG. 4 is a cut through perspective view of a conventional fuel system.

FIG. 5 is a cut through perspective view of a fuel system, according to an embodiment of the present disclosure.

FIG. 6 is a cut through perspective view of a fuel system showing a ferrule assembly, according to an embodiment of the present disclosure.

FIG. 7 is a cut through perspective view of a fuel system, according to another embodiment of the present disclosure.

FIG. 8 is a cut through perspective view of an interior section of a fuel/air mixer of a fuel system showing a placement of a plurality of openings (spray wells) from a fuel nozzle in fluid communication with the fuel supply ring of the fuel system, according to an embodiment of the present disclosure.

FIG. 9 is a longitudinal cross-sectional view of a fuel system, according to an embodiment of the present disclosure.

### DETAILED DESCRIPTION

Various embodiments of the present disclosure are discussed in detail below. While specific embodiments are discussed, this is done for illustration purposes only. A person skilled in the relevant art will recognize that other components and configurations may be used without departing from the spirit and scope of the present disclosure.

An integral fuel nozzle-mixer device (fuel injection & mixing device) with angled Jet-In-Crossflow (JIC) fuel injection is provided, for lean-burn combustor (e.g., TAPS) applications, for turbine engine (e.g., smaller jet engines). In addition to the fuel injection & mixing device, a ferrule assembly (with purge holes) mounted on deflector to allow axial/radial relative movement between the injection device (fuel nozzle) and the deflector is also provided. Relative to the conventional fuel-nozzle mixer devices for TAPS engines, the fuel supply ring is moved forward and housed in the “mixer” body, which would allow reducing the fuel-nozzle center-body diameter for compactness. The mixer can be a typical radial or ax-rad mixer (slots or vanes for axial), while the fuel nozzle can be a typical combustor (TAPS) design.

Furthermore, providing a single piece fuel-nozzle and mixer, and angled injection has numerous benefits. By providing an angled JIC main injection with the injector being moved forward, this allows a step-shaped fuel nozzle design with a lower center-body radius. In addition, by forming the fuel nozzle integral with the fuel/air mixer, a single piece injection device provides a reduction in weight and fewer components to service. Providing a ferrule assembly brazed to deflector also allows radial and axial relative movement between the deflector and the injection device. These features enable compactness and down-sizing of fuel-nozzle and fuel/air mixer for smaller engines. Reducing fuel-nozzle center-body diameter currently poses challenges on packaging the fuel supply circuit, and pilot vanes. Angled (more axial) injection also reduces the requirement of high fuel injection pressure, and hence enables lower fuel pump pressure requirements and lesser sensitivity to geometry tilt/alignment and autoignition. Furthermore, the integral design enables eliminating sensitivity of auto-ignition margin to tilt and immersion of the fuel nozzle and mixer.

In addition to solving the key challenges on fuel-nozzle compactness and additional auto-ignition margin, the design offers following technical/commercial benefits: (1) lower pump pressure requirements due to more axial injection, (2) shorter mixer length due to angled injection moving forward, hence compact/lighter parts, (3) lower weight and size due to elimination of the mixer Anti-Rotation (AR) tabs, baseplate, mixer retainer, and shorter mixer, (4) the mixer becomes Line Replacement Unit enabling on wing replacement in the case of damage and (5) reduced part count.

Moving the fuel supply ring forward, and making the injection angular, frees up the space below the fuel-nozzle centerbody. This allows reducing the centerbody diameter through a stepped design. Once the centerbody diameter is lower, mixer outside diameter (OD) can also be reduced, thus making the fuel nozzle and the mixer assembly more compact. Angled injection implies that fuel injection will have an axial component, and, hence, will not need high jet-momentum ratios or J-ratios (like current radial injection designs) for penetrating into the cross-flow. This will reduce the pump delivery pressure requirements, and, hence, provide the ability to use lesser expensive or more durable pumps. Making the fuel nozzle and the fuel/air mixer as single piece can also eliminate any relative movement between the two, thereby having no relative tilt or immersion change.

Reference will now be made in detail to present embodiments of the present disclosure, one or more examples of which are illustrated in the accompanying drawings. The detailed description uses numerical and letter designations to refer to features in the drawings. Like or similar designations in the drawings and description have been used to refer to like or similar parts of the present disclosure. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

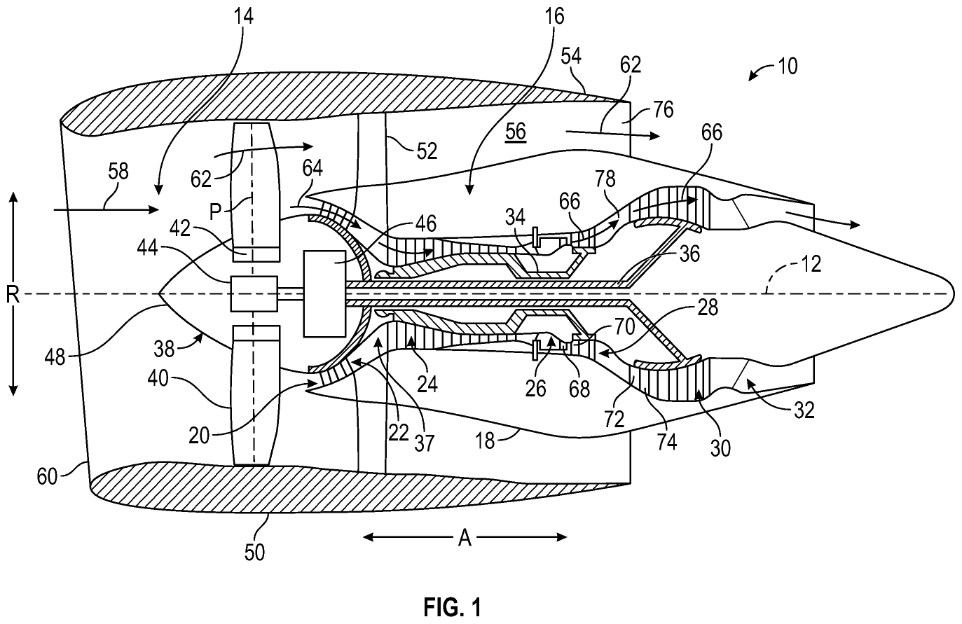

Referring now to the drawings, wherein identical numerals indicate the same elements throughout the figures, FIG. 1 is a schematic cross-sectional view of a gas turbine engine, according to an embodiment of the present disclosure. More particularly, for the embodiment of FIG. 1, the gas turbine engine is a turbofan engine 10, referred to herein as “turbofan engine 10.” The turbofan engine 10 can be a high bypass turbofan engine. As shown in FIG. 1, the turbofan engine 10 defines an axial direction A (extending parallel to a longitudinal centerline 12 provided for reference) and a radial direction R, generally perpendicular to the axial direction A. The turbofan engine 10 includes a fan section 14 and a core turbine engine 16 disposed downstream from the fan section 14. The term “downstream” is used herein with reference to the air flow direction 58.

The core turbine engine 16 depicted generally includes an outer casing 18 that is substantially tubular and that defines an annular inlet 20. The outer casing 18 encases, in serial flow relationship, a compressor section including a booster or low pressure compressor 22 (LP compressor) and a high pressure compressor 24 (HP compressor), a combustion section 26, a turbine section including a high pressure turbine 28 (HP turbine) and a low pressure turbine 30 (LP turbine), and a jet exhaust nozzle section 32. A high pressure (HP) shaft or spool 34 drivingly connects the high pressure turbine 28 to the high pressure compressor 24. A low pressure (LP) shaft or spool 36 drivingly connects the low pressure turbine 30 to the low pressure compressor 22. The compressor section, combustion section 26, turbine section, and jet exhaust nozzle section 32 together define a core air flow path 37.

For the embodiment depicted, the fan section 14 includes a fan 38 with a variable pitch having a plurality of fan blades 40 coupled to a disk 42 in a spaced apart manner. As depicted, the fan blades 40 extend outwardly from disk 42 generally along the radial direction R. Each of the fan blades 40 is rotatable relative to the disk 42 about a pitch axis P by virtue of the fan blades 40 being operatively coupled to an actuation member 44 configured to collectively vary the pitch of the fan blades 40 in unison. The fan blades 40, disk 42, and actuation member 44 are together rotatable about the longitudinal centerline 12 (longitudinal axis) by LP shaft or spool 36 across a power gear box 46. The power gear box 46 includes a plurality of gears for adjusting or controlling the rotational speed of the fan 38 relative to the LP shaft or spool 36 to a more efficient rotational fan speed.

The disk 42 is covered by rotatable front hub 48 aerodynamically contoured to promote an air flow through the plurality of fan blades 40. Additionally, the fan section 14 includes an annular fan casing or nacelle 50 that circumferentially surrounds the fan 38 and/or at least a portion of the core turbine engine 16. The nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass air flow passage 56 therebetween.

During operation of the turbofan engine 10, a volume of air flow enters the turbofan engine 10 in air flow direction 58 through an associated inlet 60 of the nacelle 50 and/or the fan section 14. As the volume of air passes across the fan blades 40, a first portion of air 62 as indicated by the arrows is directed or routed into the bypass air flow passage 56 and a second portion of air 64 as indicated by the arrow is directed or routed into the core air flow path 37, or, more specifically, into the low pressure compressor 22. The ratio between the first portion of air 62 indicated by the arrows and the second portion of air 64 indicated by arrows is commonly known as a bypass ratio. The pressure of the second portion of air 64 indicated by arrows is then increased as it is routed through the high pressure compressor 24 and into the combustion section 26, where it is mixed with fuel and burned to provide combustion gases 66.

The combustion gases 66 are routed through the high pressure turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the high pressure compressor 24. The combustion gases 66 are then routed through the low pressure turbine 30 where a second portion of thermal and kinetic energy is extracted from the combustion gases 66 via sequential stages of low pressure turbine stator vanes 72 that are coupled to the outer casing 18 and low pressure turbine rotor blades 74 that are coupled to the LP shaft or spool 36, thus causing the LP shaft or spool 36 to rotate, thereby supporting operation of the low pressure compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass air flow passage 56 before the first portion of air is exhausted from a fan nozzle exhaust section 76 of the turbofan engine 10, also providing propulsive thrust. The high pressure turbine 28, the low pressure turbine 30, and the jet exhaust nozzle section 32 at least partially define a hot gas path 78 for routing the combustion gases 66 through the core turbine engine 16.

It should be appreciated, however, that the turbofan engine 10 depicted in FIG. 1 is by way of example only, and that, in other exemplary embodiments, the turbofan engine 10 may have any other suitable configuration. It should also be appreciated that, in still other exemplary embodiments, aspects of the present disclosure may be incorporated into any other suitable gas turbine engine. For example, in other exemplary embodiments, aspects of the present disclosure may be incorporated into, e.g., a turboshaft engine, a turboprop engine, a turbocore engine, a turbojet engine, etc.

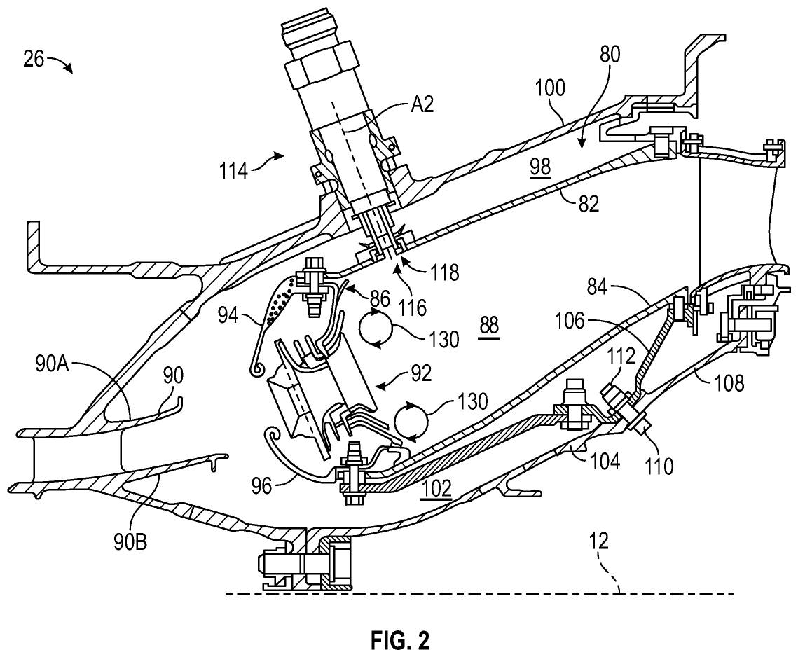

FIG. 2 is a schematic, cross-sectional view of the combustion section 26 of the turbofan engine 10 of FIG. 1, according to an embodiment of the present disclosure. The combustion section 26 generally includes a combustor 80 that generates the combustion gases discharged into the turbine section, or, more particularly, into the high pressure turbine 28. The combustor 80 includes an outer liner 82, an inner liner 84, and a dome 86. The outer liner 82, inner liner 84, and dome 86 together define a combustion chamber 88. In addition, a diffuser 90 is positioned upstream of the combustion chamber 88. The diffuser 90 has an outer diffuser wall 90A and an inner diffuser wall 90B. The inner diffuser wall 90B is closer to longitudinal centerline 12. The diffuser 90 receives an air flow from the compressor section and provides a flow of compressed air to the combustor 80. In an embodiment, the diffuser 90 provides the flow of compressed air to a single circumferential row of fuel/air mixers 92. In an embodiment, the dome 86 of the combustor 80 is configured as a single annular dome, and the circumferential row of fuel/air mixers 92 is provided within openings formed in the dome 86 (air feeding dome or combustor dome). However, in other embodiments, a multiple annular dome can also be used.

In an embodiment, the diffuser 90 can be used to slow the high speed, highly compressed, air from a compressor (not shown) to a velocity optimal for the combustor. Furthermore, the diffuser 90 can also be configured to limit the flow distortion as much as possible by avoiding flow effects like boundary layer separation. Like most other gas turbine engine components, the diffuser 90 is generally designed to be as light as possible to reduce weight of the overall engine.

A fuel nozzle (not shown in FIG. 2) provides fuel to fuel/air mixers 92 depending upon a desired performance of the combustor 80 at various engine operating states. The fuel nozzle and fuel/air mixers 92 will be described further in detail in the following paragraphs. In the embodiment shown in FIG. 2, an outer cowl 94 (e.g., annular cowl) and an inner cowl 96 (e.g., annular cowl) are located upstream of the combustion chamber 88 so as to direct air flow into fuel/air mixers 92. The outer cowl 94 and the inner cowl 96 may also direct a portion of the flow of air from the diffuser 90 to an outer passage 98 defined between the outer liner 82 and an outer casing 100 and an inner passage 102 defined between the inner liner 84 and an inner casing 104. In addition, an inner support cone 106 is further shown as being connected to a nozzle support 108 using a plurality of bolts 110 and nuts 112. However, other combustion sections may include any other suitable structural configurations.

In some embodiments, the outer liner 82 and the inner liner 84 can be formed of a Ceramic Matrix Composite (CMC), which is a non-metallic material having high temperature capability. Exemplary composite materials utilized for such liners include silicon carbide, silicon, silica or alumina matrix materials, and combinations thereof. Typically, ceramic fibers are embedded within the matrix such as oxidation stable reinforcing fibers including monofilaments like sapphire and silicon carbide, as well as rovings and yarn including silicon carbide, alumina silicates, and chopped whiskers and fibers, and, optionally, ceramic particles (e.g., oxides of Si, Al, Zr, Y and combinations thereof) and inorganic fillers (e.g., pyrophyllite, wollastonite, mica, talc, kyanite and montmorillonite). CMC materials may have coefficients of thermal expansion in the range of about 1.3×10⁻⁶ in/in/° F. to about 3.5×10⁻⁶ in/in/° F. in a temperature range of 1000° F. to 1200° F.

By contrast, other components of the combustor 80 or combustion section 26, such as the outer casing 100, inner casing 104, and other support members of the combustion section 26, may be formed of a metal, such as a nickel-based superalloy (which may have a coefficient of thermal expansion of about 8.3 to 8.6×10⁻⁶ in/in/° F. in a temperature range of approximately 1000° F. to 1200° F.) or cobalt-based superalloy (which may have a coefficient of thermal expansion of about 9.2 to 9.4×10⁻⁶ in/in/° F.). Outer liner 82 and inner liner 84 may support an extreme temperature environment presented in combustion chamber 88.

The combustor 80 is also provided with an igniter 114. The igniter 114 is provided to ignite the fuel/air mixture supplied to combustion chamber 88 of the combustor 80. The igniter 114 is attached to the outer casing 100 of the combustor 80 in a substantially fixed manner. Additionally, the igniter 114 extends generally along an axial direction A2, defining a distal end 116 that is positioned proximate to an opening in a combustor member of the combustion chamber 88. The distal end 116 is positioned proximate to an opening 118 within the outer liner 82 of the combustor 80 to the combustion chamber 88.

The outer liner 82 and the inner liner 84 have a plurality of holes (not shown) provided therein. The holes are distributed along a surface of the outer liner 82 and the inner liner 84 to allow air to enter to the combustion chamber 88. Alternatively, the outer liner 82 and inner liner 84 can be made from a porous material. The outer liner 82 and the inner liner 84 contain the combustion process and introduce the various air flows (intermediate, dilution, and cooling) into the combustion chamber 88.

In an embodiment, the dome 86 of the combustor 80 together with the outer liner 82 and the inner liner 84 define a swirler 130. The air flows through the swirler 130 as the air enters the combustion chamber 88. The role of the dome 86 and the swirler 130 is to generate turbulence in the air flow to rapidly mix the air with the fuel. The swirler establishes a local low-pressure zone that forces some of the combustion products to recirculate, as illustrated in FIG. 2, creating high turbulence. The dome 86 and the swirler 130 are designed so as not to generate more turbulence than is needed to sufficiently mix the fuel and the air.

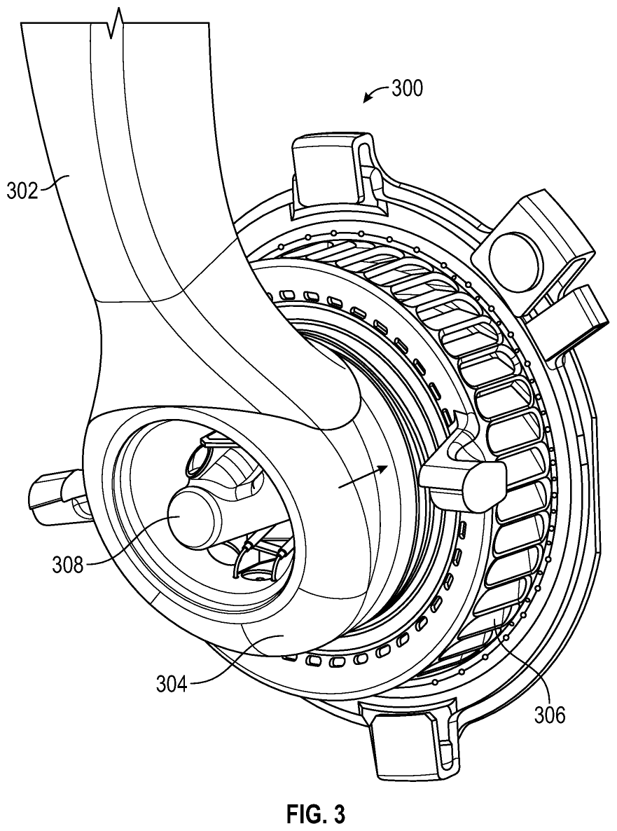

FIG. 3 is a perspective view of a fuel system 300, according to an embodiment of the present disclosure. The fuel system 300 includes a fuel supply stem 302 and fuel supply ring 304 that are in fluid communication with the fuel/air mixer 306. The fuel supply stem 302 of the fuel system 300 is a fuel conduit configured to deliver fuel (not shown in FIG. 3) to the fuel supply ring 304, which in turn distributes fuel via a fuel nozzle to the fuel/air mixer 306 where the fuel is mixed with air in a controlled ratio. The fuel system 300 also has a pilot fuel nozzle 308. The pilot fuel nozzle 308 is configured to deliver constantly a small fuel amount to the fuel/air mixer 306 to provide a pilot flame to ignite the fuel/air mixture upon injection of fuel through the fuel nozzle.

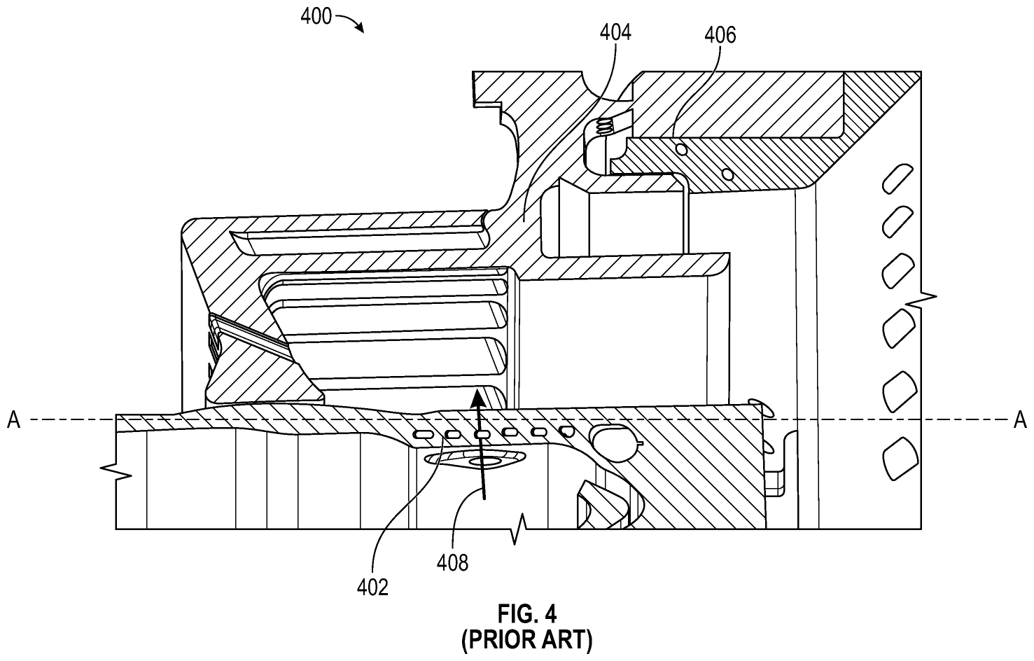

FIG. 4 is a cut through perspective view of a conventional fuel system 400. The conventional fuel system 400 includes a fuel nozzle 402 (FN) and a fuel/air mixer 404. As shown in FIG. 4, the fuel nozzle 402 and fuel/air mixer 404 are two separate components. The fuel nozzle 402 and the fuel/air mixer 404 can have a relative axial motion along longitudinal axis A-A and tilt relative to the longitudinal axis A-A. The fuel/air mixer is provided with Anti-Rotation tabs to prevent rotation. The conventional fuel system 400 also includes a deflector 406. The fuel/air mixer 404 is constrained axially to the deflector 406 using retainers brazed to the deflector 406. In the conventional fuel system 400, the fuel jets radially outwardly, as depicted by the arrow 408, through the fuel nozzle 402 into the fuel/air mixer 404 where the fuel mixes with air.

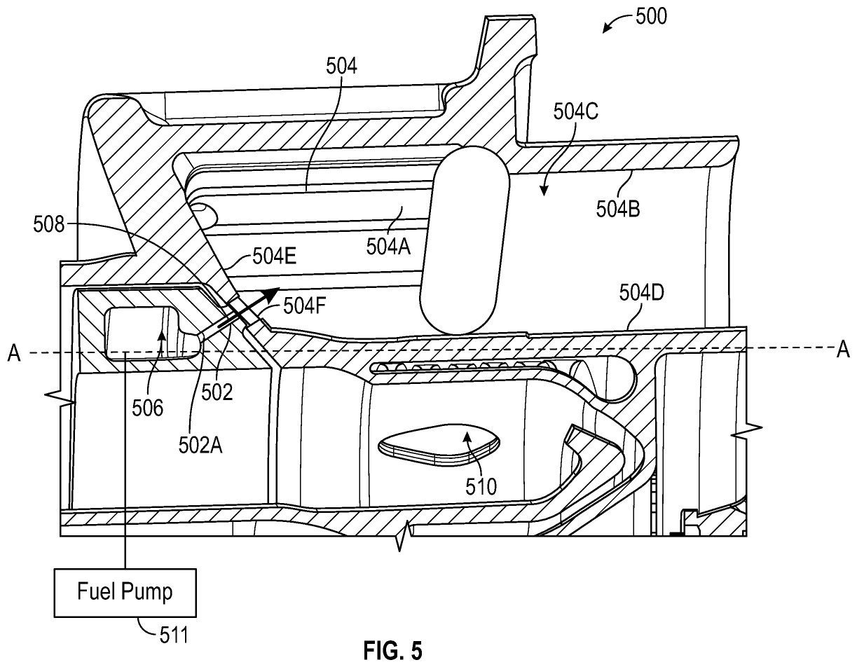

FIG. 5 is a cut through perspective view of a fuel system 500 according to an embodiment of the present disclosure. The fuel system 500 includes a fuel nozzle 502 (FN) and a fuel/air mixer 504. In an embodiment, the fuel nozzle 502 and the fuel/air mixer 504 can be two separate components that can be joined or linked together using fasteners, or welded/brazed together. For example, the fuel nozzle 502 and the fuel/air mixer 504 can be made of different materials and joined together during assembly using fasteners or the like. In another embodiment, the fuel nozzle 502 and the fuel/air mixer 504 can be integrated as one component or piece. For example, in this case, the fuel nozzle 502 and the fuel/air mixer 504 can be formed from a same material through a method such as additive/3D printing. The fuel system 500 also includes fuel supply ring 506 that is configured to deliver fuel circumferentially into the fuel nozzle 502. The fuel nozzle 502 may include a plurality of circumferentially spaced apart openings 502A in the fuel supply ring 506 to allow the fuel to jet into the fuel/air mixer 504, to generate a jet-in-crossflow of fuel 508, as shown by arrow. The fuel/air mixer 504 has a body 504B defining a chamber 504C. The fuel/air mixer 504 also includes a plurality of vanes 504A in the body 504B through which air penetrates to mix with the jet fuel or jet-in-crossflow of fuel 508, as indicated by the arrow, inside the chamber 504C of the fuel/air mixer 504.

As shown in FIG. 5, the fuel nozzle 502 is located forwardly relative to the fuel/air mixer 504. In other words, the injector on the fuel nozzle 502 is located forward of the fuel/air mixer 504. In an embodiment, the fuel supply ring 506 is moved forward and housed in the body 504B of the fuel/air mixer 504. In addition, the jet-in-crossflow of the fuel 508 shown by an arrow is angled relative to a foot 504D of the body 504B of the fuel/air mixer 504. In an embodiment, the fuel supply ring 506 and the fuel nozzle 502 are in contact with a forward portion 504E of the body 504B of the fuel/air mixer 504. The forward portion 504E of the body 504B of the fuel/air mixer 504 is angled relative to the foot 504D so that the fuel jets through a port or orifice 504F at the forward portion 504E at an injection angle between ten degrees and thirty degrees relative to the longitudinal axis A-A in a direction of foot 504D. In an embodiment, the foot 504D of the body 504B of the fuel/air mixer 504 is located generally within the direction of the longitudinal axis A-A. As it can be appreciated, however, the angle range can also vary depending on the nozzle configuration and desired fuel-to-air ratio. For example, the angle range can be between five degrees and forty-five degrees). This configuration frees up space in the centerbody 510. Diameter of the centerbody 510 can thus be reduced allowing the fuel system 500 to be substantially compact or overall smaller. A compactness of the fuel system 500 can further be enhanced when the fuel nozzle 502 (FN) and fuel/air mixer 504 are integrated as one component. By providing the fuel nozzle 502 integrated with the fuel/air mixer 504, the fuel nozzle 502 and fuel/air mixer do not need to be attached to each other and thus reducing a number or even eliminating components needed to attach the fuel nozzle 502 to the fuel/air mixer 504. The fuel system 500 also includes a fuel pump 511 (shown schematically in FIG. 5) configured to deliver fuel into the fuel supply ring 506 via the fuel supply stem 302 shown in FIG. 3. The fuel pump 511 is in fluid communication with the fuel nozzle 502 via the fuel supply ring 506. An angle of the jet-in-crossflow of the fuel 508 relative to the foot 504D of the body 504B of the fuel/air mixer 504 is configured to lower a pressure of the fuel pump 511 needed to generate the jet-in-crossflow (JIC) of the fuel 508.

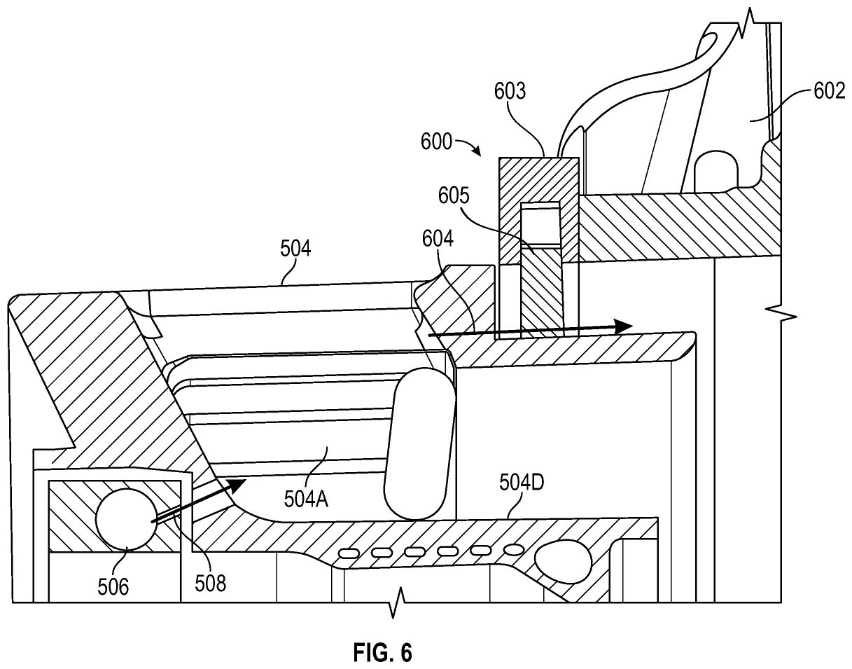

FIG. 6 is a cut through perspective view of a fuel system 500 showing a ferrule assembly 600, according to an embodiment of the present disclosure. The fuel system further includes a ferrule assembly 600. The ferrule assembly 600 is used to connect the fuel/air mixer 504 to the combustor 602. The ferrule assembly 600 (with purge holes) is mounted on deflector 603 to allow radial relative movement between the injection device (integral fuel nozzle and mixer) and the deflector 603. The ferrule assembly has a floating plate 605 with or without holes. The floating plate 605 allows the radial movement of the fuel nozzle-mixer, relative to the deflector 603. The fuel/air mixer 504 can be provided with vanes 504A (e.g., radial vanes, axial vanes, rad-ax, or axial slots).

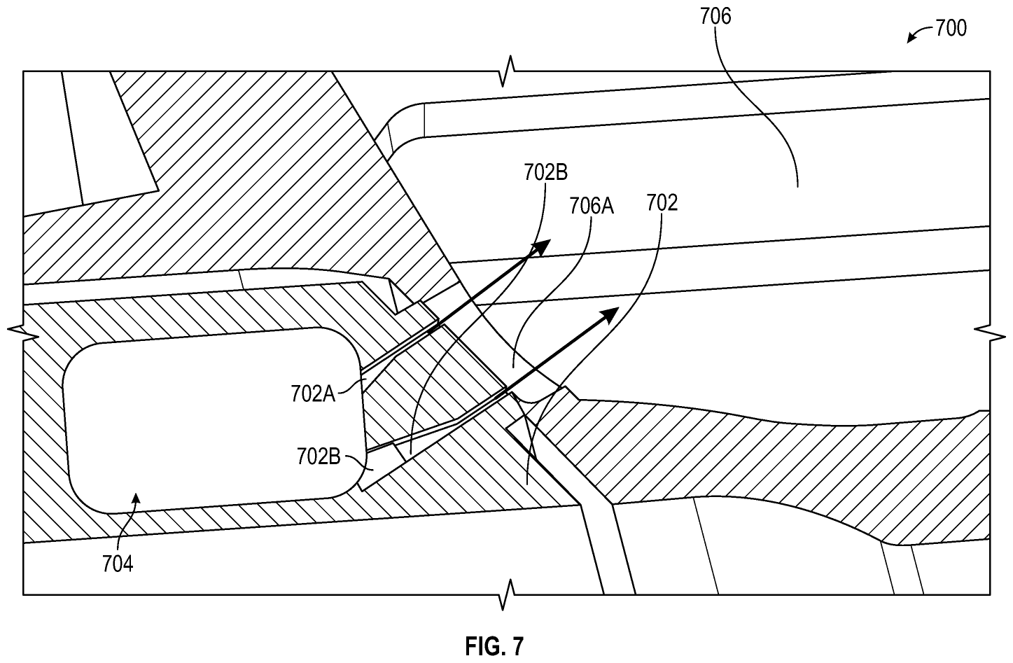

FIG. 7 is a cut through perspective view of a fuel system 700, according to another embodiment of the present disclosure. The fuel system 700 is similar in many aspects to the fuel system 500. Therefore, similar features are not further described in the following paragraph. However, one difference to be noted is that the fuel system 700 has a fuel nozzle 702 that includes a plurality (e.g., a pair) of openings 702A and 702B in the fuel nozzle 702 leading to a port in a plurality of ports 706A in the fuel/air mixer 706. In this configuration, fuel from fuel supply ring 704 is injected by the fuel nozzle 702 as pre-filming conical sheets from a plurality of injection points into the fuel/air mixer 706 and create pressure swirl-type injection that mixes with the air in the fuel/air mixer 706. For example, this configuration enables an enhanced mixing of the fuel with air to achieve a better combustion process when the fuel/air mixture is ignited

In an embodiment, the fuel nozzle includes a plurality of openings 702A, 702B and the fuel/air mixer includes the plurality of ports 706A. Each of at least pair of openings 702A, 702B of the plurality of openings 702A, 702B of the fuel nozzle 702 is in communication with a corresponding single port in the plurality of ports 706A in the fuel/air mixer 706. Each of at least pair of openings 702A, 702B is configured to generate a pressure swirl in an annular film of fuel to mix with air in the fuel/air mixer 706.

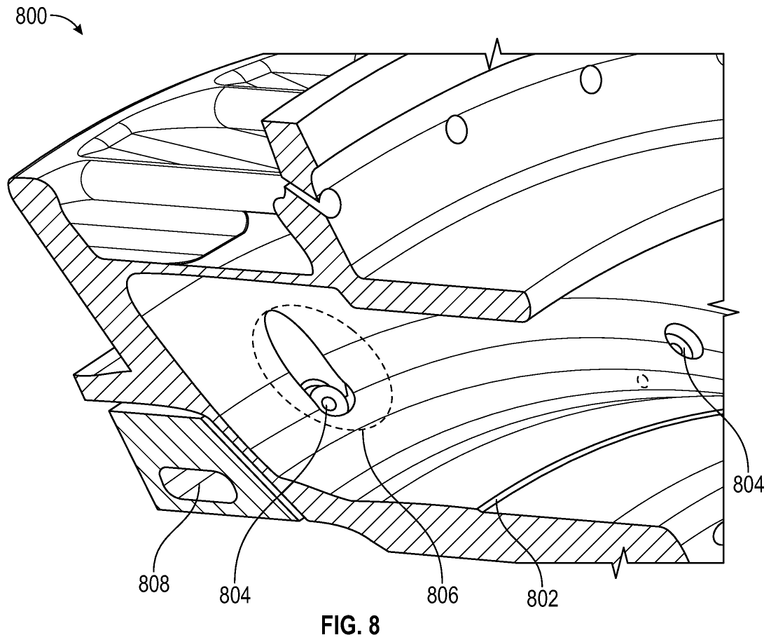

FIG. 8 is a cut through perspective view of an interior section of a fuel/air mixer 802 of a fuel system 800 showing the placement of a plurality of openings 804 (spray wells) from a fuel nozzle 806 in fluid communication with the fuel supply ring 808 of the fuel system 800, according to an embodiment of the present disclosure. In an embodiment, the openings 804 are in communication with both the fuel supply ring 808 and the fuel/air mixer 802. In an embodiment, the fuel/air mixer 802 and the fuel supply ring 808 have an annular shape and the plurality of openings 804 (spray wells) are distributed along a circumference of the annular shape to distribute the fuel substantially evenly within the fuel/air mixer 802.

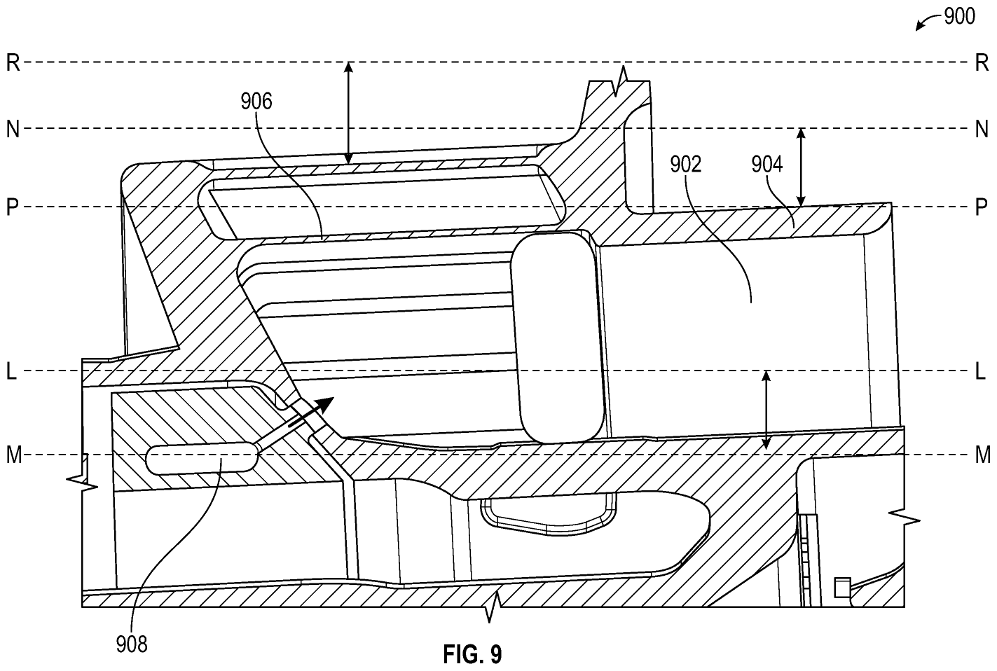

FIG. 9 is a longitudinal cross-section view of a fuel system 900, according to an embodiment of the present disclosure. The line L-L shows a position of a centerbody diameter of a conventional fuel system. The line L-L is drawn on top of the longitudinal cross-section view of the fuel system 900 to show relative position to the fuel system 900. The line M-M shows a position of a centerbody diameter of fuel system 900. Therefore, the centerbody diameter of the fuel system 900 is reduced by a distance separating line L-L to line M-M. The line N-N shows a position of a lip of the fuel/air mixer of a conventional fuel system. Line P-P shows a position of a lip 904 of the fuel/air mixer 902 of the fuel system 900. As shown in FIG. 9, the lip 904 of the fuel/air mixer 902 of the fuel system 900 is lowered relative to the conventional fuel system. The line R-R indicates the position of the outside diameter (OD) of the mixer-vane of the fuel/air mixer of a conventional fuel system (not shown). As shown in FIG. 9, the position of the outside diameter (OD) of the mixer vanes 906 of the fuel/air mixer 902 is also reduced. The reduction in the centerbody diameter and the reduction of the lip 904 of the fuel/air mixer 902 and the outside diameter (OD) of the mixer vanes 906 of the fuel/air mixer 902 provides a fuel system 900 that is substantially compact while the fuel nozzle diameter of the fuel system 900 remains the same as the conventional fuel system. In addition, the main fuel supply ring 908 in the fuel system 900 moves forward freeing up space below the centerbody.

Moving the fuel supply ring forward and making the injection angular frees up the space below the fuel-nozzle centerbody. This allows reducing the centerbody diameter through a stepped design. The term “forward” is used herein to indicate that the position of the fuel supply ring is described relative to the mixer vanes 906. In conventional fuel systems, the fuel ring is almost ¾th downstream of the mixer vanes. In contrast, in an embodiment, the fuel ring is more forward relative to mixer vanes 906, almost before the vanes start. Once the centerbody diameter is lower, mixer outside diameter (OD) can also be reduced, thus making the fuel nozzle and the mixer assembly more compact. Angled injection implies that fuel injection will have an axial component, and hence, will not need high J-ratios (like current radial injection designs) for penetrating into the cross-flow. This will reduce the pump delivery pressure requirements, and hence, provide the ability to utilize lesser expensive to cheaper or more durable pumps. Making the fuel nozzle and the mixer as a single piece will eliminate any relative movement between the two, thereby having no relative tilt or immersion change.

Furthermore, providing a single piece fuel-nozzle and mixer, and angled injection, has numerous benefits. By providing an angled JIC main injection with the fuel injector moved forward, a step-shaped fuel nozzle design with a lower center-body radius can be provided. In addition, by forming the fuel nozzle integral with the main mixer, for example, a single piece injection device is provided allowing weight reduction and fewer components to service. Providing a ferrule assembly brazed to deflector also allows radial and axial relative movement between the deflector and the injection device. These features enable compactness and down-sizing of fuel-nozzles and mixer for smaller engines. Reducing fuel-nozzle center-body diameter currently poses challenges on packaging the fuel supply circuit and pilot vanes. Compact combustor (TAPS) injection allows using low fuel pump pressure that has reduced sensitivity to geometry tilt/alignment and autoignition. In addition, by providing more axial injection, lower fuel pump pressure is provided. Furthermore, the integral design allows eliminating sensitivity of auto-ignition margin to tilt and immersion.

In addition to solving the key challenges on fuel-nozzle compactness, additional auto-ignition margin, the design offers following technical/commercial benefits: (1) lower pump pressure requirements due to more axial injection, (2) shorter mixer length due to angled injection moving forward, hence compact/lighter parts, (3) lower weight and size due to elimination of mixer anti-rotation (AR) tabs, baseplate, mixer retainer, and shorter mixer. (4) the mixer becomes Line Replacement Unit (LRU) on wing replacement in the case of damage, and (5) fewer parts.

As it must be appreciated from the above paragraphs, there is provided a fuel system for a turbine engine. According to claim 1, the fuel system includes a fuel/air mixer configured to mix air with fuel in a controlled fuel/air ratio, the fuel/air mixer having a body defining a chamber; and a fuel nozzle in fluid communication with the fuel/air mixer, the fuel nozzle being configured to inject fuel into the chamber of the fuel/air mixer, wherein the fuel nozzle is located forwardly relative to the body of the fuel/air mixer so that a jet-in-crossflow of the fuel is angled relative to a foot of the body of the fuel/air mixer.

The fuel system according to claim 1, wherein the jet-in-crossflow of the fuel is at an angle between five degrees and forty-five degrees. relative to a longitudinal axis in a direction of the foot of the body of the fuel/air mixer.

The fuel system according to any of the previous claims, wherein the angle of the jet-in-crossflow of the fuel relative to a longitudinal axis in a direction of the foot of the body of the fuel/air mixer is between ten degrees and thirty degrees.

The fuel system according to any of the previous claims, further comprising a fuel pump in communication with the fuel nozzle, wherein an angle of the jet-in-crossflow of the fuel relative to the foot of the body of the fuel/air mixer is configured to lower a pressure of the fuel pump needed to generate the jet-in-crossflow of the fuel.

The fuel system according to any of the previous claims, wherein the fuel nozzle and the fuel/air mixer are integrated as one component.

The fuel system according to any of the previous claims, wherein the fuel nozzle and the fuel/air mixer are formed from a same material.

The fuel system according to any of the previous claims, wherein the fuel nozzle includes a plurality of circumferentially spaced apart openings configured to inject the j et-in-crossflow of the fuel into the chamber of the fuel/air mixer.

The fuel system according to any of the previous claims, wherein the fuel nozzle comprises a plurality of openings and the fuel/air mixer comprises a plurality of ports, each of at least a pair of the plurality of openings of the fuel nozzle being in communication with a corresponding single port in the plurality of ports in the fuel/air mixer, and each of the at least pair of the plurality of openings being configured to generate a pressure swirl in an annular film of fuel to mix with air in the fuel/air mixer.

The fuel system according to any of the previous claims, wherein the fuel/air mixer comprises a plurality of vanes configured to introduce air therethrough to mix with the fuel introduced through the fuel nozzle.

The fuel system according to any of the previous claims, further comprising: a fuel supply ring in fluid communication with the fuel nozzle to distribute fuel to the fuel/air mixer through the fuel nozzle; and a fuel supply stem in fluid communication with the fuel supply ring to deliver fuel to the fuel supply ring.

The fuel system according to any of the previous claims, wherein the body of the fuel/air mixer and the fuel supply ring have an annular shape and the fuel nozzle comprises a plurality of openings distributed around a circumference of the fuel supply ring to distribute fuel circumferentially into the annular shape of the body of the fuel/air mixer.

The fuel system according to any of the previous claims, wherein the fuel supply ring is located forwardly relative to the body of the fuel/air mixer so that the jet-in-crossflow of the fuel from the fuel nozzle is angled relative to the foot of the body of the fuel/air mixer.

The fuel system according to any of the previous claims, wherein a forward location of the fuel supply ring, and an angular injection of the j et-in-crossflow of the fuel free up a space below a centerbody of the fuel system that reduces a centerbody diameter and reduces an outside diameter of the fuel/air mixer.

As it must be further appreciated from the above paragraphs, there is also provided a turbine engine. According to another claim the turbine engine comprises: (A) a compressor section configured to generate compressed air; (B) a turbine section located downstream of the compressor section; (C) a combustion section disposed between the compressor section and the turbine section; and (D) a fuel system in fluid communication with the combustion section, the fuel system being configured to provide a fuel/air mixture to the combustion section. The fuel system comprises: (a) a fuel/air mixer configured to mix air with fuel in a controlled fuel/air ratio, the fuel/air mixer having a body defining a chamber; and (b) a fuel nozzle in fluid communication with the fuel/air mixer, the fuel nozzle being configured to inject fuel into the chamber of the fuel/air mixer, wherein the fuel nozzle is located forwardly relative the body of the fuel/air mixer so that a jet-in-crossflow of the fuel is angled relative to a foot of the body of the fuel/air mixer.

The turbine engine according to the previous claim, wherein the jet-in-crossflow of the fuel is at an angle between five degrees and forty-five degrees relative to a longitudinal axis in a direction of the foot of the body of the fuel/air mixer.

The turbine engine according to any of the previous claims, wherein the fuel nozzle and the fuel/air mixer are integrated as one component.

The turbine engine according to any of the previous claims, wherein the fuel nozzle includes a plurality of circumferentially spaced apart openings configured to inject fuel into the chamber of the fuel/air mixer.

The turbine engine according to any of the previous claims, wherein the fuel nozzle comprises a plurality of openings and the fuel/air mixer comprises a plurality of ports, each pair of the plurality of openings of the fuel nozzle being in communication with a corresponding single port in the plurality of ports in the fuel/air mixer, and at least each pair of the plurality of openings being configured to generate a pressure swirl in an annular film of fuel to mix with air in the fuel/air mixer.

The turbine engine according to any of the previous claims, further comprising: a fuel supply ring in fluid communication with the fuel nozzle to distribute fuel to the fuel/air mixer through the fuel nozzle; and a fuel supply stem in fluid communication with the fuel supply ring to deliver fuel to the fuel supply ring.

The turbine engine according to any of the previous claims, wherein the body of the fuel/air mixer and the fuel supply ring have an annular shape and the fuel nozzle comprises a plurality of openings distributed around a circumference of the fuel supply ring to distribute fuel circumferentially into the annular shape of the body of the fuel/air mixer.

Although the foregoing description is directed to the preferred embodiments of the present disclosure, it is noted that other variations and modifications will be apparent to those skilled in the art, and may be made without departing from the spirit or scope of the disclosure. Moreover, features described in connection with one embodiment of the present disclosure may be used in conjunction with other embodiments, even if not explicitly stated above.

1. A fuel system for a turbine engine, the fuel system comprising:
a fuel/air mixer configured to mix air with fuel in a controlled fuel/air ratio, the fuel/air mixer having a body defining a chamber; and
a fuel nozzle in fluid communication with the fuel/air mixer, the fuel nozzle being configured to inject the fuel into the chamber of the fuel/air mixer,
wherein the fuel nozzle is located forwardly relative to the body of the fuel/air mixer so that a jet-in-crossflow of the fuel is angled relative to a foot of the body of the fuel/air mixer.

2. The fuel system according to claim 1, wherein the jet-in-crossflow of the fuel is at an angle between five degrees and forty-five degrees. relative to a longitudinal axis in a direction of the foot of the body of the fuel/air mixer.

3. The fuel system according to claim 2, wherein the angle of the jet-in-crossflow of the fuel relative to the longitudinal axis in the direction of the foot of the body of the fuel/air mixer is between ten degrees and thirty degrees.

4. The fuel system according to claim 1, further comprising a fuel pump in communication with the fuel nozzle, wherein an angle of the jet-in-crossflow of the fuel relative to the foot of the body of the fuel/air mixer is configured to lower a pressure of the fuel pump needed to generate the jet-in-crossflow of the fuel.

5. The fuel system according to claim 1, wherein the fuel nozzle and the fuel/air mixer are integrated as one component.

6. The fuel system according to claim 5, wherein the fuel nozzle and the fuel/air mixer are formed from a same material.

7. The fuel system according to claim 1, wherein the fuel nozzle includes a plurality of circumferentially spaced apart openings configured to inject the jet-in-crossflow of the fuel into the chamber of the fuel/air mixer.

8. The fuel system according to claim 1, wherein the fuel nozzle comprises a plurality of openings and the fuel/air mixer comprises a plurality of ports, each of at least a pair of the plurality of openings of the fuel nozzle being in communication with a corresponding single port in the plurality of ports in the fuel/air mixer, and each of the at least pair of the plurality of openings being configured to generate a pressure swirl in an annular film of the fuel to mix with the air in the fuel/air mixer.

9. The fuel system according to claim 1, wherein the fuel/air mixer comprises a plurality of vanes configured to introduce the air therethrough to mix with the fuel introduced through the fuel nozzle.

10. The fuel system according to claim 1, further comprising:
a fuel supply ring in fluid communication with the fuel nozzle to distribute the fuel to the fuel/air mixer through the fuel nozzle; and
a fuel supply stem in fluid communication with the fuel supply ring to deliver the fuel to the fuel supply ring.

11. The fuel system according to claim 10, wherein the body of the fuel/air mixer and the fuel supply ring have an annular shape and the fuel nozzle comprises a plurality of openings distributed around a circumference of the fuel supply ring to distribute the fuel circumferentially into the annular shape of the body of the fuel/air mixer.

12. The fuel system according to claim 10, wherein the fuel supply ring is located forwardly relative to the body of the fuel/air mixer so that the jet-in-crossflow of the fuel from the fuel nozzle is angled relative to the foot of the body of the fuel/air mixer.

13. The fuel system according to claim 12, wherein a forward location of the fuel supply ring, and an angular injection of the jet-in-crossflow of the fuel free up a space below a centerbody of the fuel system that reduces a centerbody diameter and reduces an outside diameter of the fuel/air mixer.

14. A turbine engine comprising:
(A) a compressor section configured to generate air that is compressed;
(B) a turbine section located downstream of the compressor section;
(C) a combustion section disposed between the compressor section and the turbine section; and
(D) a fuel system in fluid communication with the combustion section, the fuel system being configured to provide a fuel/air mixture to the combustion section, the fuel system comprising:
(a) a fuel/air mixer configured to mix the air with fuel in a controlled fuel/air ratio, the fuel/air mixer having a body defining a chamber; and
(b) a fuel nozzle in fluid communication with the fuel/air mixer, the fuel nozzle being configured to inject the fuel into the chamber of the fuel/air mixer,
wherein the fuel nozzle is located forwardly relative the body of the fuel/air mixer so that a jet-in-crossflow of the fuel is angled relative to a foot of the body of the fuel/air mixer.

15. The turbine engine according to claim 14, wherein the jet-in-crossflow of the fuel is at an angle between five degrees and forty-five degrees relative to a longitudinal axis in a direction of the foot of the body of the fuel/air mixer.

16. The turbine engine according to claim 14, wherein the fuel nozzle and the fuel/air mixer are integrated as one component.

17. The turbine engine according to claim 14, wherein the fuel nozzle includes a plurality of circumferentially spaced apart openings configured to inject the fuel into the chamber of the fuel/air mixer.

18. The turbine engine according to claim 14, wherein the fuel nozzle comprises a plurality of openings and the fuel/air mixer comprises a plurality of ports, each pair of the plurality of openings of the fuel nozzle being in communication with a corresponding single port in the plurality of ports in the fuel/air mixer, and at least each pair of the plurality of openings being configured to generate a pressure swirl in an annular film of the fuel to mix with the air in the fuel/air mixer.

19. The turbine engine according to claim 14, further comprising:
a fuel supply ring in fluid communication with the fuel nozzle to distribute the fuel to the fuel/air mixer through the fuel nozzle; and
a fuel supply stem in fluid communication with the fuel supply ring to deliver fuel to the fuel supply ring.

20. The turbine engine according to claim 19, wherein the body of the fuel/air mixer and the fuel supply ring have an annular shape and the fuel nozzle comprises a plurality of openings distributed around a circumference of the fuel supply ring to distribute fuel circumferentially into the annular shape of the body of the fuel/air mixer.
